(19) United States
(12) Patent Application Publication
(10) Pub. No.: US 2026/0055242 A1
(43) Pub. Date: Feb. 26, 2026

(54) METALGEL AND PREPARATION METHOD THEREFOR

(71) Applicant: NANJING UNIVERSITY, Nanjing (CN)

(72) Inventors: Ye ZHANG, Nanjing (CN); Jia Cheng Wang, Nanjing (CN); Ting Ting Ye, Nanjing (CN); Yi Ding Jiao, Nanjing (CN)

(21) Appl. No.: 19/202,943

(22) Filed: May 8, 2025

(30) Foreign Application Priority Data
Aug. 22, 2024 (CN) 2024111159674.6

(51) Int. Cl. C08J 3/075; C08J 9/28; C08K 3/08

(52) U.S. Cl. CPC C08J 3/075; C08J 9/28; C08K 3/08; C08J 2305/00

(57) ABSTRACT

The present invention relates to the technical field of gels and polymer composite materials, and discloses a metalgel and a preparation method therefor. The method includes the steps of: dissolving a polymer powder in a good solvent to obtain a polymer solution; mixing a liquid metal with the polymer solution uniformly by homogenization; and removing the good solvent from the liquid metal-polymer mixed solution, to obtain the metalgel. Compared with related art, the present invention has the following advantages. A liquid metal continuum as a fluid phase is stably immobilized in a nano-scale polymer network through interaction. The unique structure enables the metalgel to have high conductivity (the electronic conductivity is up to 3.18×10⁶ S/m), soft tissue-like softness (the Young's modulus is as low as 70 kPa) and low air permeability (the oxygen permeability is as low as 4.50×10⁻²² m²/s/Pa).

### TECHNICAL FIELD

The present invention relates to the technical field of gels and composite materials, and more specifically, to a metalgel and a preparation method therefor.

### BACKGROUND

Gel is a semi-solid material in which a fluid is immobilized within a three-dimensional colloidal or polymer network throughout its volume. The fluid, as a primary component of the gel, determines the fundamental physical and chemical properties of the gel. Hydrogels contains water as the fluid, and exhibit biocompatibility, electrical insulation, softness, and affinity to water-soluble substances. Organogels are developed by replacing water with various organic liquids, and they show good hydrophobicity-related properties. When an ionic liquid is introduced as the fluid, the ionic conductivity and thermal stability of the material can be changed.

Liquid metals have gained great attention due to their fluidity, high electrical conductivity, low gas permeability, and biocompatibility, and have become widely used functional materials in recent years. By associating a liquid metal with a polymer, a material can be enabled to retain metallic properties while maintaining softness. This method has been extensively researched. In such liquid metal-polymer composites, the liquid metal typically exists within the polymer matrix as island, skeleton, or layered structures. However, limited content and poor connectivity of the liquid metal often result in inadequate electrical conductivity. Moreover, the lack of strong interactions between the polymer matrix and the liquid metal compromises the electromechanical stability during dynamic deformation.

In related art, for example, Chinese Patent No. CN 115073764 A discloses a liquid metal microgel and a preparation method and use thereof. The liquid metal microgel contains a core and a shell. The core consists of micro/nano-scale liquid metal particles, and the shell is a gel layer formed in-situ by a polymeric material on the surface of the liquid metal particles. However, no any technical teachings on how to utilize a liquid metal as a fluid phase in a metalgel to enable the gel material to have both high electronic conductivity and softness are not disclosed in related art.

### SUMMARY

### 1. Technical Problem to be Solved

In view of the technical challenge of utilizing a liquid metal as a fluid phase in a metalgel to enable the gel and composite material to have both high electronic conductivity and softness existing in related art, the present invention provides a metalgel and a preparation method therefor. A novel gel material is developed based upon an existing gel system, where a liquid metal serves as a fluid phase in the gel, and a nanoscale polymer network immobilizes the liquid metal continuum through an interactive force, to achieve a high electronic conductivity and softness, and enable the material to have stable performance upon physical deformation or in various environments.

### 2. Technical Solution

The objects of the present invention can be accomplished through the following technical solutions.

A method for preparing a metalgel includes the following steps:
preparing a polymer solution by adding a polymer powder to a good solvent, dissolving, and stirring until uniform, to a polymer solution;
preparing a liquid metal-polymer mixed solution by adding a liquid metal to the polymer solution, uniformly dispersing the mixed solution by a homogenizer, to obtain the liquid metal-polymer mixed solution; and
treating the liquid metal-polymer mixed solution by removing the good solvent from the uniformly dispersed mixed solution by heating, freeze drying, or other methods, to obtain the metalgel.

Still further, the polymer solution is prepared by preparing a t-type carrageenan solution; preparing a sodium alginate solution; preparing a gellan gum solution; preparing a hyaluromic acid solution, and preparing a poly(vinylidene fluoride-hexafluoropropylene) solution.

Still further, the t-type carrageenan solution is prepared specifically by dissolving 0.80 wt %-4.80 wt % of a t-type carrageenan power in deionized water, and continuously magnetically stirring for 2 hrs at a temperature of 80° C. until the power is dissolved, to obtain the t-type carrageenan solution.

The sodium alginate solution is prepared specifically by dissolving 0.80 wt %-4.80 wt % of a sodium alginate powder in deionized water, and continuously magnetically stirring for 2 hrs at a temperature of 25° C. until the power is dissolved, to obtain the sodium alginate solution.

Still further, the gellan gum solution is prepared specifically by dissolving 0.80 wt %-4.80 wt % of a gellan gum powder in deionized water, and continuously magnetically stirring for 2 hrs at a temperature of 25° C. until the power is dissolved, to obtain the gellan gum solution.

The hyaluromic acid solution is prepared specifically by dissolving 0.80 wt %-4.80 wt % of a hyaluromic acid powder in deionized water, and continuously magnetically stirring for 2 hrs at a temperature of 25° C. until the power is dissolved, to obtain the hyaluromic acid solution.

The poly(vinylidene fluoride-hexafluoropropylene) solution is prepared specifically by dissolving 0.80 wt %-4.80 wt % of poly(vinylidene fluoride-hexafluoropropylene) particles in N-methylpyrrolidone, and continuously magnetically stirring for 2 hrs at a temperature of 25° C. until the particles are dissolved, to obtain the poly(vinylidene fluoride-hexafluoropropylene) solution.

Still further, the liquid metal-polymer mixed solution is prepared by preparing a gallium-indium alloy-ι-type carrageenan mixed solution; preparing a gallium-ι-type carrageenan mixed solution; preparing a gallium-indium-tin alloy-ι-type carrageenan mixed solution; preparing a gallium-indium alloy-sodium alginate mixed solution; preparing a gallium-indium alloy-gellan gum mixed solution; preparing a gallium-indium alloy-hyaluromic acid mixed solution; and preparing a gallium-indium alloy-poly(vinylidene fluoride-hexafluoropropylene) mixed solution.

Still further, the liquid metal-polymer mixed solution is prepared specifically by
mixing liquid metal gallium-indium alloy with the t-type carrageenan solution at a weight ratio of 1:1-7:3, and stirring and shearing for 5 min-15 min by a hand-held homogenizer at a speed of 8000 rpm-15000 rpm at a temperature of 80° C., to obtain the gallium-indium alloy-ι-type carrageenan mixed solution;
mixing liquid metal gallium with the t-type carrageenan solution at a weight ratio of 1:1-7:3, and stirring and shearing for 5 min-15 min by a hand-held homogenizer at a speed of 8000 rpm-15000 rpm at a temperature of 80° C., to obtain the gallium-ι-type carrageenan mixed solution; and
mixing liquid metal gallium-indium-tin alloy with the t-type carrageenan solution at a weight ratio of 1:1-7:3, and stirring and shearing for 5 min-15 min by a hand-held homogenizer at a speed of 8000 rpm-15000 rpm at a temperature of 80° C., to obtain the gallium-indium-tin alloy-ι-type carrageenan mixed solution.

Still further, the liquid metal-polymer mixed solution is further prepared by
mixing liquid metal gallium-indium alloy with the sodium alginate solution at a weight ratio of 1:1-7:3, and stirring and shearing for 5 min-15 min by a hand-held homogenizer at a speed of 8000 rpm-15000 rpm at a temperature of 25° C., to obtain the gallium-indium alloy-sodium alginate mixed solution;
mixing liquid metal gallium-indium alloy with the gellan gum solution at a weight ratio of 1:1-7:3, and stirring and shearing for 5 min-15 min by a hand-held homogenizer at a speed of 8000 rpm-15000 rpm at a temperature of 25° C., to obtain the gallium-indium alloy-gellan gum mixed solution;
mixing liquid metal gallium-indium alloy with the hyaluromic acid solution at a weight ratio of 1:1-7:3, and stirring and shearing for 5 min-15 min by a hand-held homogenizer at a speed of 8000 rpm-15000 rpm at a temperature of 25° C., to obtain the gallium-indium alloy-hyaluromic acid mixed solution; and
mixing liquid metal gallium-indium alloy with the poly(vinylidene fluoride-hexafluoropropylene) solution at a weight ratio of 1:1-7:3, and stirring and shearing for 5 min-15 min by a hand-held homogenizer at a speed of 8000 rpm-15000 rpm at a temperature of 25° C., to obtain the gallium-indium alloy-poly(vinylidene fluoride-hexafluoropropylene) mixed solution.

Still further, the liquid metal-polymer mixed solution is treated specifically by
adding the liquid metal-polymer mixed solution to a polytetrafluoroethylene dish, and removing the good solvent by allowing the dish to stand in an environment of 25° C.-80° C., to obtain the metalgel.

The novel metalgel prepared according to the method for preparing a metalgel includes a liquid metal and a polymer network, where the liquid metal forms a continuum to serve as a fluid phase of the gel; and the nanoscale polymer network immobilizes the liquid metal fluid through interactions.

### 3. Beneficial Effects

Compared with the prior art, the present invention has the following beneficial effects.
(1) A novel gel system is developed, where a liquid metal is used as a fluid phase in the gel material for the first time.
(2) A completely different material structure from the existing liquid metal composite materials is obtained.
(3) Different polymer network systems are used, which can form an interactive force with the liquid metal, such that the interactive force between the polymer network and the metal is improved and the problems of structural phase separation and instability are avoided.
(4) A series of metalgels prepared all show high electronic conductivity and adjustable mechanical properties.
(5) The high conductivity and softness of the metalgel make it possible for the metalgel to be used in soft and stretchable electromagnetic shielding materials, sealing materials with ultra-low oxygen permeability and implantable electrodes with great advantages.

### BRIEF DESCRIPTION OF THE DRAWINGS

FIG. 1 shows a schematic computed tomography image of a metalgel in an embodiment of the present invention;

FIG. 2 shows a schematic computed tomography image of a metalgel in an embodiment of the present invention and a schematic diagram of a polymer network retrieved therefrom;

FIG. 3 shows a schematic scanning electron microscopy image of a nanoscale polymer network in a metalgel in an embodiment of the present invention;

FIG. 4 is a schematic diagram showing a preparation process of a metalgel in an embodiment of the present invention;

FIG. 5 is a schematic diagram showing the changes of electronic conductivity and Young's modulus of a gallium-indium alloy-ι-type carrageenan metalgel with a liquid metal content in an embodiment of the present invention;

FIG. 6 is a schematic diagram showing the electromagnetic shielding effectiveness of a gallium-indium alloy-ι-type carrageenan metalgel in an initial state and a deformed state when used as an electromagnetic shielding material in an embodiment of the present invention;

FIG. 7 is a schematic diagram comparing the oxygen permeability and Young's modulus of a gallium-indium alloy-ι-type carrageenan metalgel with other sealing materials in an embodiment of the present invention;

FIG. 8 is a schematic diagram comparing the performance of a gallium-indium alloy-poly(vinylidene fluoride-hexafluoropropylene) metalgel with other electrode materials when used for electrical stimulation of sciatic nerve in rats in an embodiment of the present invention;

FIG. 9 is a schematic diagram comparing the performance after long-term implantation of a gallium-indium alloy-poly(vinylidene fluoride-hexafluoropropylene) metalgel with other electrode materials when used for electrical stimulation of sciatic nerve in rats in an embodiment of the present invention;

FIG. 10 schematically shows pictures of a gallium-indium alloy-poly(vinylidene fluoride-hexafluoropropylene) metalgel and polyimide attached to the inner wall of the intestinal tract in an embodiment of the present invention;

FIG. 11 is a schematic diagram showing the histopathological sections of the intestinal tract after a gallium-indium alloy-poly(vinylidene fluoride-hexafluoropropylene) metalgel and polyimide are implanted in an embodiment of the present invention; and

FIG. 12 is a schematic diagram showing signals monitored in real time by a gallium-indium alloy-poly(vinylidene fluoride-hexafluoropropylene) metalgel used as a signal monitoring electrode in the intestinal tract in an embodiment of the present invention.

### DETAILED DESCRIPTION

The present invention will be described in detail with reference to the accompanying drawings and specific examples.

### Example 1

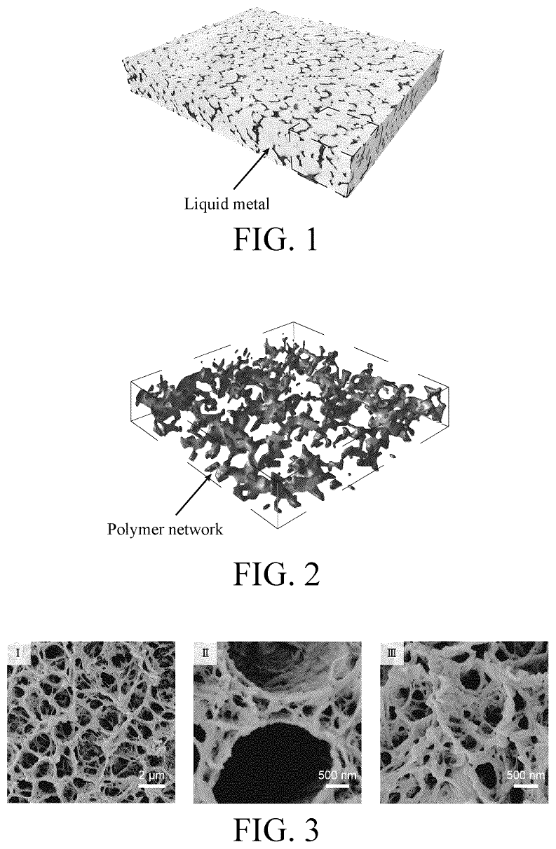

As shown in FIG. 1 to FIG. 3, this examples provides a metalgel including a liquid metal and a polymer network.

The liquid metal, as a fluid phase in the metalgel, accounts for 85.1%-92.4% by volume, and the liquid metal in the metalgel is interconnected to form a continuum.

The polymer network has a nano-dispersed three-dimensional porous network structure, which can uniformly and stably immobilize the liquid metal fluid.

Specifically, the liquid metal is interconnected throughout the whole bulk phase, forming a continuum, and the polymer network presents a nano-dispersed three-dimensional porous structure. The interaction between the polymer network and the liquid metal immobilizes the liquid metal in the polymer network and ensures that the liquid metal does not leak.

Specifically, inside the gel, the liquid metal continuum, as a fluid phase in the gel, provides a good electronic path for the metalgel. The metalgel has an electronic conductivity close to the intrinsic value of the liquid metal that is up to 3.18×10⁶ S/m. The three-dimensional porous polymer network provides a good mechanical support and adjustable mechanical performance for the metalgel (the Young's modulus is as low as 70 kPa), and a large amount of liquid metal is stably immobilized in the nano-dispersed polymer network, which enhances the stability of the gel.

According to the types of the liquid metals and polymer networks used, seven metalgels are formed, including a gallium-indium alloy-ι-type carrageenan metalgel, a gallium-ι-type carrageenan metalgel, a gallium-indium-tin alloy-ι-type carrageenan metalgel, a gallium-indium alloy-sodium alginate metalgel, a gallium-indium alloy-gellan gum metalgel, a gallium-indium alloy-hyaluromic acid metalgel, and a gallium-indium alloy-poly(vinylidene fluoride-hexafluoropropylene) metalgel, having an electronic conductivity of higher than 2.00×10⁶ S/m and different mechanical performances (the Young's modulus is as low as 70 kPa). Poly(vinylidene fluoride-hexafluoropropylene), i.e. PVDF-HFP, is a polymer, which is formed by copolymerization of vinylidene fluoride and hexafluoropropylene.

The novel metalgel in this example is a brand-new metalgel material, which has a broad application prospect in soft wearable and implantable electronic devices, and can be used in soft and stretchable electromagnetic shielding materials with high shielding effectiveness, soft sealing materials with ultra-low oxygen permeability, implantable electrodes, and so on.

Specifically, the gallium-indium alloy-ι-type carrageenan metalgel, as a soft and stretchable electromagnetic shielding material with high electromagnetic shielding effectiveness, can be used for high-efficiency electromagnetic shielding, showing an average total electromagnetic shielding effectiveness of 47.8 dB-65.4 dB in a frequency range of 8.2 GHz-12.4 GHz, an average total electromagnetic shielding effectiveness of 48 dB-65.8 dB at 50% tensile strain, and an average total electromagnetic shielding effectiveness of 50 dB-67.4 dB at 100% tensile strain, which basically remains unchanged. Even after repeatedly stretching at 100% tensile strain for 1000 times, the electromagnetic shielding effectiveness does not decline.

The gallium-indium alloy-ι-type carrageenan metalgel can be used as a sealing material with ultra-low oxygen permeability. When used as a sealing material, it has ultra-low oxygen permeability (4.5×10⁻²² m²/s/Pa) comparable to that of an aluminum-plastic film, and is as soft as traditional soft materials such as hydrogel (the Young's modulus is 336 kPa).

The gallium-indium alloy-poly(vinylidene fluoride-hexafluoropropylene) metalgel can be used as a sciatic nerve stimulation electrode as soft as biological tissue. When used as a sciatic nerve stimulation electrode, the metalgel can achieve more obvious stimulation effect at a low voltage compared with a rigid platinum electrode and a printed liquid metal electrode, and has stable performance over long-term implantation;

The gallium-indium alloy-poly(vinylidene fluoride-hexafluoropropylene) metalgel can be used as a biosensor electrode on intestinal mucosa. Unlike a polyimide film commonly used in a soft electronic product, the metalgel can well fit to the pleats of the mucosa, and will not cause physical damage to the intestinal mucosa after being implanted into the colon of rats, and the mucosal connexin ZO-1 remains intact. Therefore, the metalgel can effectively detect the coupled changes of electrical signals and ion concentrations in the intestinal tract.

### Example 2

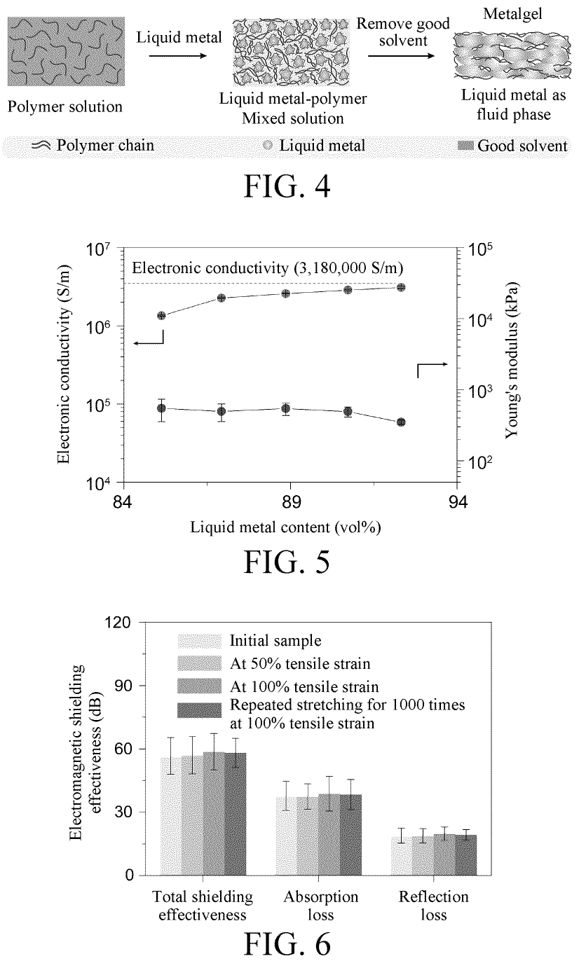

In this example, a metalgel was prepared through a process as shown in FIG. 4. The process was as follows.

### Preparation of Polymer Solutions:

### Preparation of ι-Type Carrageenan Solution:

Specifically, 0.80 wt %-4.80 wt % of a 1-type carrageenan power was dissolved in deionized water, and continuously magnetically stirred for 2 hrs at a temperature of 80° C. until the power was dissolved, to obtain a ι-type carrageenan solution.

### Preparation of Sodium Alginate Solution:

Specifically, 0.80 wt %-4.80 wt % of a sodium alginate powder was dissolved in deionized water, and continuously magnetically stirred for 2 hrs at a temperature of 25° C. until the power was dissolved, to obtain a sodium alginate solution.

### Preparation of Gellan Gum Solution:

Specifically, 0.80 wt %-4.80 wt % of a gellan gum powder was dissolved in deionized water, and continuously magnetically stirred for 2 hrs at a temperature of 25° C. until the power was dissolved, to obtain a gellan gum solution.

### Preparation of Hyaluromic Acid Solution:

Specifically, 0.80 wt %-4.80 wt % of a hyaluromic acid powder was dissolved in deionized water, and continuously magnetically stirred for 2 hrs at a temperature of 25° C. until the powder was dissolved, to obtain a hyaluromic acid solution.

### Preparation of Poly(Vinylidene Fluoride-Hexafluoropropylene) Solution:

0.80 wt %-4.80 wt % of poly(vinylidene fluoride-hexafluoropropylene) particles was dissolved in N-methylpyrrolidone, and continuously magnetically stirred for 2 hrs at a temperature of 25° C. until the particles were dissolved, to obtain a poly(vinylidene fluoride-hexafluoropropylene) solution.

### Preparation of Liquid Metal-Polymer Mixed Solutions:

Liquid metal gallium-indium alloy was mixed with the t-type carrageenan solution at a weight ratio of 1:1-7:3, and stirred and sheared for 5 min-15 min by a hand-held homogenizer at a speed of 8000 rpm-15000 rpm at a temperature of 80° C., to obtain a gallium-indium alloy-ι-type carrageenan mixed solution.

Liquid metal gallium was mixed with the t-type carrageenan solution at a weight ratio of 1:1-7:3, and stirred and sheared for 5 min-15 min by a hand-held homogenizer at a speed of 8000 rpm-15000 rpm at a temperature of 80° C., to obtain a gallium-ι-type carrageenan mixed solution.

Liquid metal gallium-indium-tin alloy was mixed with the t-type carrageenan solution at a weight ratio of 1:1-7:3, and stirred and sheared for 5-15 min by a hand-held homogenizer at a speed of 8000 rpm-15000 rpm at a temperature of 80° C., to obtain a gallium-indium-tin alloy-ι-type carrageenan mixed solution.

Liquid metal gallium-indium alloy was mixed with the sodium alginate solution at a weight ratio of 1:1-7:3, and stirred and sheared for 5 min-15 min by a hand-held homogenizer at a speed of 8000 rpm-15000 rpm at a temperature of 25° C., to obtain a gallium-indium alloy-sodium alginate mixed solution.

Liquid metal gallium-indium alloy was mixed with the gellan gum solution at a weight ratio of 1:1-7:3, and stirred and sheared for 5 min-15 min by a hand-held homogenizer at a speed of 8000 rpm-15000 rpm at a temperature of 25° C., to obtain a gallium-indium alloy-gellan gum mixed solution.

Liquid metal gallium-indium alloy was mixed with the hyaluromic acid solution at a weight ratio of 1:1-7:3, and stirred and sheared for 5 min-15 min by a hand-held homogenizer at a speed of 8000-15000 rpm at a temperature of 25° C., to obtain a gallium-indium alloy-hyaluromic acid mixed solution.

Liquid metal gallium-indium alloy was mixed with the poly(vinylidene fluoride-hexafluoropropylene) solution at a weight ratio of 1:1-7:3, and stirred and sheared for 5 min-15 min by a hand-held homogenizer at a speed of 8000-15000 rpm at a temperature of 25° C., to obtain a gallium-indium alloy-poly(vinylidene fluoride-hexafluoropropylene) mixed solution.

Specifically, after the liquid metal in this step underwent high-speed stirring and shearing by the homogenizer, small droplets were formed and dispersed in the solution, and the polymer network was dispersed on the metal surface and in the good solvent.

### Treatment of Liquid Metal-Polymer Mixed Solution:

The evenly dispersed mixed solution was heated to remove the good solvent.

Specifically, the obtained different systems of mixed solutions of liquid metals and polymers were respectively added into a polytetrafluoroethylene dish, and then allowed to stand in an environment of 25° C.-80° C. to remove the good solvent, so as to obtain the metalgel.

In this step, initially, the liquid metal droplets were dispersed in the form of nano-droplets, in which the entangled polymer chains form a physically cross-linked network. These networks also capture a large amount of good solvent. With the progress of drying, the good solvent in these networks was gradually replaced by the liquid metal. The micropores originally filled with water between liquid metal droplets were transformed into nanopores filled with the liquid metal. Finally, the liquid metal fluid became a dominant component, forming a continuous structure; and the polymer network was embedded in this liquid metal continuum.

The metalgel prepared according to the above steps has excellent electronic conductivity and various mechanical properties. As shown in Table 1, metalgels can be successfully prepared based on different polymer networks (t-type carrageenan, sodium alginate, gellan gum, hyaluromic acid, and poly(vinylidene fluoride-hexafluoropropylene)) and different liquid metals (gallium-indium alloy, gallium, and gallium-indium-tin alloy). The liquid metal dominates (accounting for >87.6 vol %) in the gel volume, indicating that the liquid metal acts as a fluid phase therein. The metalgels have an electronic conductivity of greater than 2.00×10⁶ S/m and a Young's modulus as low as 70 kPa, and show good softness.

TABLE 1
Liquid metal content, electronic conductivity and
Young's modulus of 7 metalgel systems based
on different polymer networks and liquid metals

| | Liquid metal | Electronic | Young's |
|---|---|---|---|
| | content | conductivity | modulus |
| Metalgel system | (vol %) | (S/m) | (kPa) |
| Gallium-indium alloy-1- | 92.40 | 3.18 × 10⁶ | 336 |
| type carrageenan | | | |
| Gallium-t-type | 92.00 | 2.09 × 10⁶ | 129 |
| carrageenan | | | |
| Gallium-indium-tin alloy- | 92.00 | 3.11 × 10⁶ | 556 |
| t-type carrageenan | | | |
| Gallium-indium alloy- | 92.50 | 2.65 × 10⁶ | 8,400 |
| sodium alginate | | | |
| Gallium-indium alloy- | 91.40 | 2.29 × 10⁶ | 15,221 |
| gellan gum | | | |
| Gallium-indium alloy- | 87.60 | 2.42 × 10⁶ | 70 |
| hyaluromic acid | | | |
| Gallium-indium alloy- | 93.30 | 2.79 × 10⁶ | 4,800 |
| poly(vinylidene fluoride- | | | |
| hexafluoropropylene) | | | |

FIG. 5 shows the changes of electronic conductivity and Young's modulus of a gallium-indium alloy-ι-type carrageenan metalgel with a liquid metal content. Taking the gallium-indium alloy-ι-type carrageenan metalgel as an example, the content of the liquid metal in the gel is adjustable. Even if the volume fraction of the liquid metal is reduced, the electronic conductivity and Young's modulus can still be maintained at a good level. When the volume fraction of the liquid metal is 92.4%, the metalgel shows an electronic conductivity of 3.18×10⁶ S/m and a Young's modulus of 336 kPa, which are better than the performances of the gel materials reported so far.

This novel metalgel material in which the liquid metal is used as a fluid phase has a special structure. That is, a liquid metal continuum is attained in the gel material, which is immobilized in the system by a nano-dispersed polymer network. This special structure allows the metalgel to have a wide use.

FIG. 6 shows the electromagnetic shielding effectiveness of a gallium-indium alloy-ι-type carrageenan metalgel in an initial state and a deformed state when used as an electromagnetic shielding material. There is an urgent need for soft and stretchable electromagnetic shielding materials with excellent shielding effectiveness. However, although traditional metals can provide a high electromagnetic shielding effectiveness, they are rigid and non-stretchable. The existing stretchable electromagnetic shielding materials often fail to meet the requirements, and show insufficient or sharply reduced electromagnetic shielding effectiveness under strain. The gallium-indium alloy-ι-type carrageenan metalgel can be used as a soft and stretchable electromagnetic shielding material with high electromagnetic shielding effectiveness, and shows an average total electromagnetic shielding effectiveness of 47.8 dB-65.4 dB in a frequency range of 8.2 GHz-12.4 GHz, an average total electromagnetic shielding effectiveness of 48 dB-65.8 dB at 50% tensile strain, and an average total electromagnetic shielding effectiveness of 50 dB-67.4 dB at 100% tensile strain, which basically remains unchanged. Even after repeatedly stretching at 100% tensile strain for 1000 times, the electromagnetic shielding effectiveness does not decline.

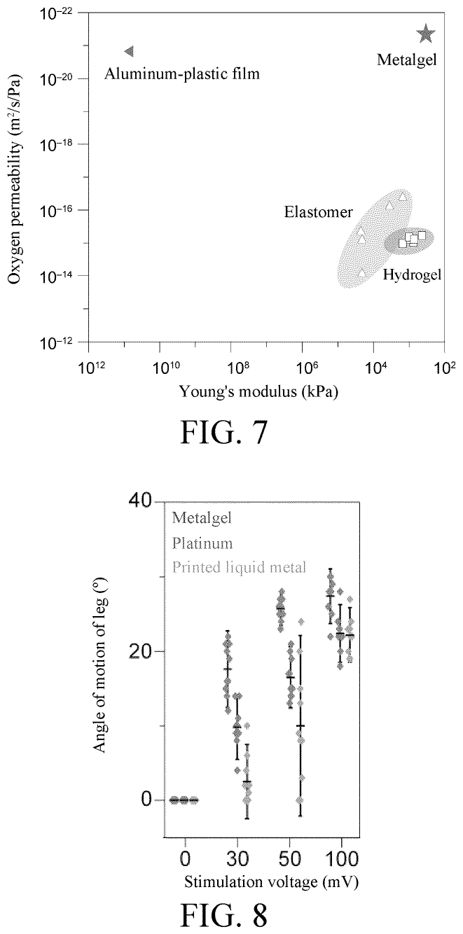

FIG. 7 compares the oxygen permeability and Young's modulus of a gallium-indium alloy-ι-type carrageenan metalgel with other sealing materials (aluminum-plastic film, elastomer and hydrogel). Soft sealing materials are an important technology for sealing an electronic device and protecting it from oxygen and other active substances, so it is very important to ensure the long-term stability of the soft sealing materials. However, soft materials including hydrogels and elastomers have the characteristics of high chain mobility and large free volume, leading to high air permeability. The metalgel has become a promising solution, which has an ultra-low oxygen permeability (4.5×10⁻²² m²/s/Pa) comparable to that of an aluminum-plastic film, and is as soft as traditional soft materials such as hydrogel (the Young's modulus is 336 kPa).

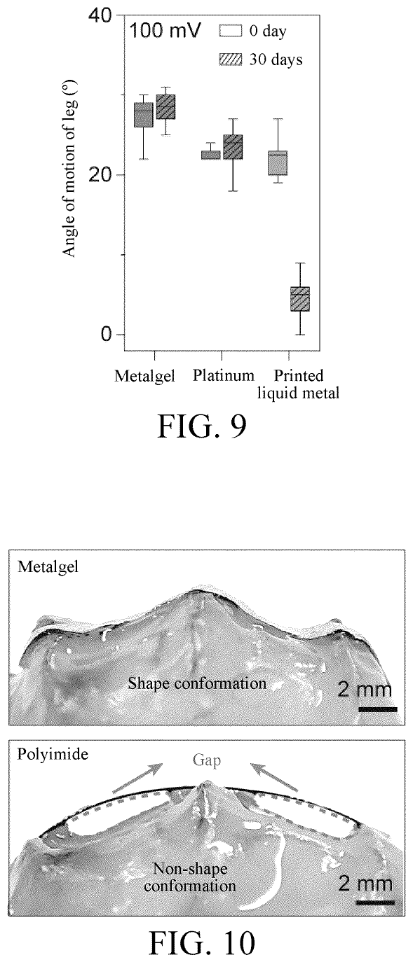

FIG. 8 and FIG. 9 are a schematic graphs comparing the performance of a gallium-indium alloy-poly(vinylidene fluoride-hexafluoropropylene) metalgel with other electrode materials (platinum and printed liquid metal) when used for electrical stimulation of sciatic nerve in rats. For implantable bioelectronic electrodes, the material is required to have metallic conductivity, tissue softness and stability in deformed state and fluid environment. These characteristics are very important for minimizing signal loss, achieving the mechanical compatibility at the device-tissue interface and reducing the immune response. The existing conductive materials cannot meet these comprehensive requirements. In contrast, soft metalgels have excellent conductivity and stability, which provide a better choice for electronic conductors in implantable bioelectronics. As shown in FIG. 8, when used as a sciatic nerve stimulation electrode that is important for the treatment of nervous system diseases, the metalgel can achieve more obvious stimulation effect at a low voltage compared with a rigid platinum electrode and a printed liquid metal electrode, and has stable performance after long-term implantation; and has stable performance over long-term implantation as shown in FIG. 9. In contrast, the performance of a printed liquid metal electrode is obviously reduced under the same conditions.

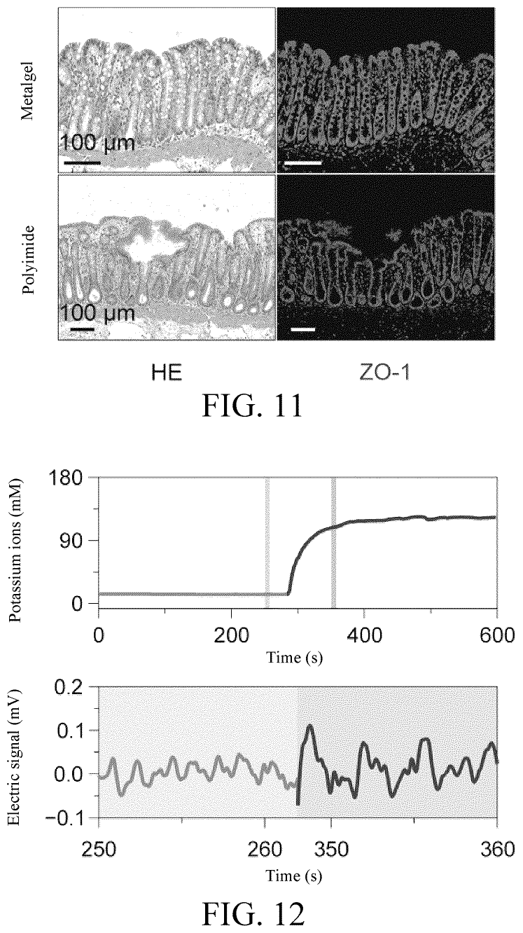

FIG. 10 to FIG. 12 show a picture, the histopathological sections of the intestinal tract, and signals monitored in real time when a gallium-indium alloy-poly(vinylidene fluoride-hexafluoropropylene) metalgel is used as a signal monitoring electrode in the intestinal tract. The materials used in implantable bioelectronics need to meet stricter standards before they are applied to complex organs such as intestines. Intestinal mucosa has rich biological characteristic signals and is a potential sensor-tissue interface for intestinal biosensing. However, the pleated intestinal inner surface makes it a challenge to construct a conformal sensor-mucosa interface. In addition, mechanically incompatible materials often cause physical damage to the mucosa, leading to the infiltration of harmful exogenous substances such as bacteria and toxins. The gallium-indium alloy-poly(vinylidene fluoride-hexafluoropropylene) metalgel can be used as a biosensor electrode on intestinal mucosa. As shown in FIG. 10, unlike a polyimide film commonly used in a soft electronic product, the metalgel can well fit to the pleats of the mucosa, to form a good sensor-mucosa interface. As shown in FIG. 11, the metalgel will not cause physical damage to the intestinal mucosa after being implanted into the colon of rats, and the mucosal connexin ZO-1 remains intact. Therefore, the metalgel can effectively detect the coupled changes of electrical signals and ion concentrations in the intestinal tract, as shown in FIG. 12.

### Example 3

In this example, a metalgel was prepared through a process as shown in FIG. 4. The process was as follows.

### Preparation of Polymer Solutions:

0.80 wt %-1.80 wt % of a t-type carrageenan powder was dissolved in deionized water.

Specifically, the power was continuously magnetically stirred for 2 hrs at a temperature of 80° C. until it was dissolved, to obtain a t-type carrageenan solution.

0.80 wt %-1.80 wt % of a sodium alginate powder was dissolved in deionized water.

Specifically, the powder was continuously magnetically stirred for 2 hrs at a temperature of 25° C. until it was dissolved, to obtain a sodium alginate solution.

0.80 wt %-1.80 wt % of a gellan gum powder was dissolved in deionized water.

Specifically, the power was continuously magnetically stirred for 2 hrs at a temperature of 25° C. until it was dissolved, to obtain a gellan gum solution.

0.80 wt %-1.80 wt % of a hyaluromic acid powder was dissolved in deionized water.

Specifically, the power was continuously magnetically stirred for 2 hrs at a temperature of 25° C. until it was dissolved, to obtain a hyaluromic acid solution.

0.80 wt %-1.80 wt % of poly(vinylidene fluoride-hexafluoropropylene) particles was dissolved in N-methylpyrrolidone.

Specifically, the particles were continuously magnetically stirred for 2 hrs at a temperature of 25° C. until they were dissolved, to obtain a poly(vinylidene fluoride-hexafluoropropylene) solution.

### Preparation of Liquid Metal-Polymer Mixed Solutions:

Liquid metal gallium-indium alloy was mixed with the t-type carrageenan solution at a weight ratio of 6:4-7:3, and stirred and sheared for 5-10 min by a hand-held homogenizer at a speed of 8000 rpm-12000 rpm at a temperature of 80° C., to obtain a gallium-indium alloy-ι-type carrageenan mixed solution.

Liquid metal gallium was mixed with the t-type carrageenan solution at a weight ratio of 6:4-7:3, and stirred and sheared for 5-10 min by a hand-held homogenizer at a speed of 8000 rpm-12000 rpm at a temperature of 80° C., to obtain a gallium-ι-type carrageenan mixed solution.

Liquid metal gallium-indium-tin alloy was mixed with the t-type carrageenan solution at a weight ratio of 6:4-7:3, and stirred and sheared for 5-10 min by a hand-held homogenizer at a speed of 8000 rpm-12000 rpm at a temperature of 80° C., to obtain a gallium-indium-tin alloy-ι-type carrageenan mixed solution.

Liquid metal gallium-indium alloy was mixed with the sodium alginate solution at a weight ratio of 1:1-6:4, and sheared for 10-15 min by a hand-held homogenizer at a speed of 8000 rpm-12000 rpm at a temperature of 25° C., to obtain a gallium-indium alloy-sodium alginate mixed solution.

Liquid metal gallium-indium alloy was mixed with the gellan gum solution at a weight ratio of 1:1-6:4, and stirred and sheared for 10-15 min by a hand-held homogenizer at a speed of 8000 rpm-12000 rpm at a temperature of 25° C., to obtain a gallium-indium alloy-gellan gum mixed solution.

Liquid metal gallium-indium alloy was mixed with the hyaluromic acid solution at a weight ratio of 1:1-6:4, and sheared for 10-15 min by a hand-held homogenizer at a speed of 8000 rpm-12000 rpm at a temperature of 25° C., to obtain a gallium-indium alloy-hyaluromic acid mixed solution.

Liquid metal gallium-indium alloy was mixed with the poly(vinylidene fluoride-hexafluoropropylene) solution at a weight ratio of 1:1-6:4, and sheared for 10-15 min by a hand-held homogenizer at a speed of 8000 rpm-12000 rpm at a temperature of 25° C., to obtain a gallium-indium alloy-poly(vinylidene fluoride-hexafluoropropylene) mixed solution.

Specifically, after the liquid metal in this step underwent high-speed stirring and shearing by the homogenizer, small droplets were formed and dispersed in the solution, and the polymer network was dispersed on the metal surface and in the good solvent.

### Treatment of Liquid Metal-Polymer Mixed Solution:

The evenly dispersed mixed solution was heated to remove the good solvent.

Specifically, the obtained different systems of mixed solutions of liquid metals and polymers were respectively added into a polytetrafluoroethylene dish, and then allowed to stand in an environment of 40° C. to remove the good solvent, so as to obtain the metalgel.

In this step, initially, the liquid metal droplets were dispersed in the form of nano-droplets, in which the entangled polymer chains form a physically cross-linked network. These networks also capture a large amount of good solvent. With the progress of drying, the good solvent in these networks was gradually replaced by the liquid metal. The micropores originally filled with water between liquid metal droplets were transformed into nanopores filled with the liquid metal. Finally, the liquid metal fluid became a dominant component, forming a continuous structure; and the polymer network was embedded in this liquid metal continuum.

### Example 4

In this example, a metalgel was prepared through a process as shown in FIG. 4. The process was as follows.

### Preparation of Polymer Solutions:

1.80 wt %-2.80 wt % of a t-type carrageenan powder was dissolved in deionized water.

Specifically, the power was continuously magnetically stirred for 2 hrs at a temperature of 80° C. until it was dissolved, to obtain a t-type carrageenan solution.

1.80 wt %-2.80 wt % of a sodium alginate powder was dissolved in deionized water.

Specifically, the powder was continuously magnetically stirred for 2 hrs at a temperature of 25° C. until it was dissolved, to obtain a sodium alginate solution.

1.80 wt %-2.80 wt % of a gellan gum powder was dissolved in deionized water.

Specifically, the power was continuously magnetically stirred for 2 hrs at a temperature of 25° C. until it was dissolved, to obtain a gellan gum solution.

1.80 wt %-2.80 wt % of a hyaluromic acid powder was dissolved in deionized water.

Specifically, the power was continuously magnetically stirred for 2 hrs at a temperature of 25° C. until it was dissolved, to obtain a hyaluromic acid solution.

1.80 wt %-2.80 wt % of poly(vinylidene fluoride-hexafluoropropylene) particles was dissolved in N-methylpyrrolidone.

Specifically, the particles were continuously magnetically stirred for 2 hrs at a temperature of 25° C. until they were dissolved, to obtain a poly(vinylidene fluoride-hexafluoropropylene) solution.

### Preparation of Liquid Metal-Polymer Mixed Solutions:

Liquid metal gallium-indium alloy was mixed with the t-type carrageenan solution at a weight ratio of 1:1-6:4, and stirred and sheared for 10-15 min by a hand-held homogenizer at a speed of 10000 rpm-15000 rpm at a temperature of 80° C., to obtain a gallium-indium alloy-ι-type carrageenan mixed solution.

Liquid metal gallium was mixed with the t-type carrageenan solution at a weight ratio of 1:1-6:4, and stirred and sheared for 10-15 min by a hand-held homogenizer at a speed of 10000 rpm-15000 rpm at a temperature of 80° C., to obtain a gallium-ι-type carrageenan mixed solution.

Liquid metal gallium-indium-tin alloy was mixed with the t-type carrageenan solution at a weight ratio of 1:1-6:4, and stirred and sheared for 10-15 min by a hand-held homogenizer at a speed of 10000 rpm-15000 rpm at a temperature of 80° C., to obtain a gallium-indium-tin alloy-ι-type carrageenan mixed solution.

Liquid metal gallium-indium alloy was mixed with the sodium alginate solution at a weight ratio of 6:4-7:3, and sheared for 5-10 min by a hand-held homogenizer at a speed of 10000 rpm-15000 rpm at a temperature of 25° C., to obtain a gallium-indium alloy-sodium alginate mixed solution.

Liquid metal gallium-indium alloy was mixed with the gellan gum solution at a weight ratio of 6:4-7:3, and stirred and sheared for 5-10 min by a hand-held homogenizer at a speed of 10000 rpm-15000 rpm at a temperature of 25° C., to obtain a gallium-indium alloy-gellan gum mixed solution.

Liquid metal gallium-indium alloy was mixed with the hyaluromic acid solution at a weight ratio of 6:4-7:3, and sheared for 5-10 min by a hand-held homogenizer at a speed of 10000 rpm-15000 rpm at a temperature of 25° C., to obtain a gallium-indium alloy-hyaluromic acid mixed solution.

Liquid metal gallium-indium alloy was mixed with the poly(vinylidene fluoride-hexafluoropropylene) solution at a weight ratio of 6:4-7:3, and sheared for 5-10 min by a hand-held homogenizer at a speed of 10000 rpm-15000 rpm at a temperature of 25° C., to obtain a gallium-indium alloy-poly(vinylidene fluoride-hexafluoropropylene) mixed solution.

Specifically, after the liquid metal in this step underwent high-speed stirring and shearing by the homogenizer, small droplets were formed and dispersed in the solution, and the polymer network was dispersed on the metal surface and in the good solvent.

### Treatment of Liquid Metal-Polymer Mixed Solution:

The evenly dispersed mixed solution was heated to remove the good solvent.

Specifically, the obtained different systems of mixed solutions of liquid metals and polymers were respectively added into a polytetrafluoroethylene dish, and then allowed to stand in an environment of 60° C. to remove the good solvent, so as to obtain the metalgel.

In this step, initially, the liquid metal droplets were dispersed in the form of nano-droplets, in which the entangled polymer chains form a physically cross-linked network. These networks also capture a large amount of good solvent. With the progress of drying, the good solvent in these networks was gradually replaced by the liquid metal. The micropores originally filled with water between liquid metal droplets were transformed into nanopores filled with the liquid metal. Finally, the liquid metal fluid became a dominant component, forming a continuous structure; and the polymer network was embedded in this liquid metal continuum.

### Example 5

In this example, a metalgel was prepared through a process as shown in FIG. 4. The process was as follows.

### Preparation of Polymer Solutions:

2.80 wt %-3.80 wt % of a t-type carrageenan powder was dissolved in deionized water.

Specifically, the power was continuously magnetically stirred for 2 hrs at a temperature of 80° C. until it was dissolved, to obtain a t-type carrageenan solution.

2.80 wt %-3.80 wt % of a sodium alginate powder was dissolved in deionized water.

Specifically, the powder was continuously magnetically stirred for 2 hrs at a temperature of 25° C. until it was dissolved, to obtain a sodium alginate solution.

2.80 wt %-3.80 wt % of a gellan gum powder was dissolved in deionized water.

Specifically, the power was continuously magnetically stirred for 2 hrs at a temperature of 25° C. until it was dissolved, to obtain a gellan gum solution.

2.80 wt %-3.80 wt % of a hyaluromic acid powder was dissolved in deionized water.

Specifically, the power was continuously magnetically stirred for 2 hrs at a temperature of 25° C. until it was dissolved, to obtain a hyaluromic acid solution.

2.80 wt %-3.80 wt % of poly(vinylidene fluoride-hexafluoropropylene) particles was dissolved in N-methylpyrrolidone.

Specifically, the particles were continuously magnetically stirred for 2 hrs at a temperature of 25° C. until they were dissolved, to obtain a poly(vinylidene fluoride-hexafluoropropylene) solution.

### Preparation of Liquid Metal-Polymer Mixed Solutions:

Liquid metal gallium-indium alloy was mixed with the t-type carrageenan solution at a weight ratio of 6:4-7:3, and stirred and sheared for 5-10 min by a hand-held homogenizer at a speed of 8000 rpm-12000 rpm at a temperature of 80° C., to obtain a gallium-indium alloy-ι-type carrageenan mixed solution.

Liquid metal gallium was mixed with the t-type carrageenan solution at a weight ratio of 1:1-6:4, and stirred and sheared for 5-10 min by a hand-held homogenizer at a speed of 8000 rpm-12000 rpm at a temperature of 80° C., to obtain a gallium-ι-type carrageenan mixed solution.

Liquid metal gallium-indium-tin alloy was mixed with the t-type carrageenan solution at a weight ratio of 6:4-7:3, and stirred and sheared for 5-10 min by a hand-held homogenizer at a speed of 8000 rpm-12000 rpm at a temperature of 80° C., to obtain a gallium-indium-tin alloy-t-type carrageenan mixed solution.

Liquid metal gallium-indium alloy was mixed with the sodium alginate solution at a weight ratio of 1:1-6:4, and sheared for 10-15 min by a hand-held homogenizer at a speed of 8000 rpm-12000 rpm at a temperature of 25° C., to obtain a gallium-indium alloy-sodium alginate mixed solution.

Liquid metal gallium-indium alloy was mixed with the gellan gum solution at a weight ratio of 6:4-7:3, and stirred and sheared for 10-15 min by a hand-held homogenizer at a speed of 8000 rpm-12000 rpm at a temperature of 25° C., to obtain a gallium-indium alloy-gellan gum mixed solution.

Liquid metal gallium-indium alloy was mixed with the hyaluromic acid solution at a weight ratio of 1:1-6:4, and sheared for 10-15 min by a hand-held homogenizer at a speed of 8000 rpm-12000 rpm at a temperature of 25° C., to obtain a gallium-indium alloy-hyaluromic acid mixed solution.

Liquid metal gallium-indium alloy was mixed with the poly(vinylidene fluoride-hexafluoropropylene) solution at a weight ratio of 1:1-6:4, and sheared for 5-10 min by a hand-held homogenizer at a speed of 10000 rpm-15000 rpm at a temperature of 25° C., to obtain a gallium-indium alloy-poly(vinylidene fluoride-hexafluoropropylene) mixed solution.

Specifically, after the liquid metal in this step underwent high-speed stirring and shearing by the homogenizer, small droplets were formed and dispersed in the solution, and the polymer network was dispersed on the metal surface and in the good solvent.

### Treatment of Liquid Metal-Polymer Mixed Solution:

The evenly dispersed mixed solution was heated to remove the good solvent.

Specifically, the obtained different systems of mixed solutions of liquid metals and polymers were respectively added into a polytetrafluoroethylene dish, and then allowed to stand in an environment of 80° C. to remove the good solvent, so as to obtain the metalgel.

In this step, initially, the liquid metal droplets were dispersed in the form of nano-droplets, in which the entangled polymer chains form a physically cross-linked network. These networks also capture a large amount of good solvent. With the progress of drying, the good solvent in these networks was gradually replaced by the liquid metal. The micropores originally filled with water between liquid metal droplets were transformed into nanopores filled with the liquid metal. Finally, the liquid metal fluid became a dominant component, forming a continuous structure; and the polymer network was embedded in this liquid metal continuum.

### Example 6

In this example, a metalgel was prepared through a process as shown in FIG. 4. The process was as follows.

### Preparation of Polymer Solutions:

3.80 wt %-4.80 wt % of a t-type carrageenan powder was dissolved in deionized water.

Specifically, the power was continuously magnetically stirred for 2 hrs at a temperature of 80° C. until it was dissolved, to obtain a t-type carrageenan solution.

3.80 wt %-4.80 wt % of a sodium alginate powder was dissolved in deionized water.

Specifically, the powder was continuously magnetically stirred for 2 hrs at a temperature of 25° C. until it was dissolved, to obtain a sodium alginate solution.

3.80 wt %-4.80 wt % of a gellan gum powder was dissolved in deionized water.

Specifically, the power was continuously magnetically stirred for 2 hrs at a temperature of 25° C. until it was dissolved, to obtain a gellan gum solution.

3.80 wt %-4.80 wt % of a hyaluromic acid powder was dissolved in deionized water.

Specifically, the power was continuously magnetically stirred for 2 hrs at a temperature of 25° C. until it was dissolved, to obtain a hyaluromic acid solution.

3.80 wt %-4.80 wt % of poly(vinylidene fluoride-hexafluoropropylene) particles was dissolved in N-methylpyrrolidone.

Specifically, the particles were continuously magnetically stirred for 2 hrs at a temperature of 25° C. until they were dissolved, to obtain a poly(vinylidene fluoride-hexafluoropropylene) solution.

### Preparation of Liquid Metal-Polymer Mixed Solutions:

Liquid metal gallium-indium alloy was mixed with the t-type carrageenan solution at a weight ratio of 3:2, and stirred and sheared for 10-15 min by a hand-held homogenizer at a speed of 10000 rpm-15000 rpm at a temperature of 80° C., to obtain a gallium-indium alloy-ι-type carrageenan mixed solution.

Liquid metal gallium was mixed with the t-type carrageenan solution at a weight ratio of 7:3, and stirred and sheared for 10-15 min by a hand-held homogenizer at a speed of 10000 rpm-15000 rpm at a temperature of 80° C., to obtain a gallium-ι-type carrageenan mixed solution.

Liquid metal gallium-indium-tin alloy was mixed with the t-type carrageenan solution at a weight ratio of 7:3, and stirred and sheared for 10-15 min by a hand-held homogenizer at a speed of 10000 rpm-15000 rpm at a temperature of 80° C., to obtain a gallium-indium-tin alloy-ι-type carrageenan mixed solution.

Liquid metal gallium-indium alloy was mixed with the sodium alginate solution at a weight ratio of 3:2, and sheared for 5-10 min by a hand-held homogenizer at a speed of 10000 rpm-15000 rpm at a temperature of 25° C., to obtain a gallium-indium alloy-sodium alginate mixed solution.

Liquid metal gallium-indium alloy was mixed with the gellan gum solution at a weight ratio of 3:2, and stirred and sheared for 5-10 min by a hand-held homogenizer at a speed of 10000 rpm-15000 rpm at a temperature of 25° C., to obtain a gallium-indium alloy-gellan gum mixed solution.

Liquid metal gallium-indium alloy was mixed with the hyaluromic acid solution at a weight ratio of 1:1, and sheared for 5-10 min by a hand-held homogenizer at a speed of 10000 rpm-15000 rpm at a temperature of 25° C., to obtain a gallium-indium alloy-hyaluromic acid mixed solution.

Liquid metal gallium-indium alloy was mixed with the poly(vinylidene fluoride-hexafluoropropylene) solution at a weight ratio of 6:4, and sheared for 5-10 min by a hand-held homogenizer at a speed of 10000 rpm-15000 rpm at a temperature of 25° C., to obtain a gallium-indium alloy-poly(vinylidene fluoride-hexafluoropropylene) mixed solution.

Specifically, after the liquid metal in this step underwent high-speed stirring and shearing by the homogenizer, small droplets were formed and dispersed in the solution, and the polymer network was dispersed on the metal surface and in the good solvent.

### Treatment of Liquid Metal-Polymer Mixed Solution:

The evenly dispersed mixed solution was heated to remove the good solvent.

Specifically, the obtained different systems of mixed solutions of liquid metals and polymers were respectively added into a polytetrafluoroethylene dish, and then allowed to stand in an environment of 60° C. to remove the good solvent, so as to obtain the metalgel.

In this step, initially, the liquid metal droplets were dispersed in the form of nano-droplets, in which the entangled polymer chains form a physically cross-linked network. These networks also capture a large amount of good solvent. With the progress of drying, the good solvent in these networks was gradually replaced by the liquid metal. The micropores originally filled with water between liquid metal droplets were transformed into nanopores filled with the liquid metal. Finally, the liquid metal fluid became a dominant component, forming a continuous structure; and the polymer network was embedded in this liquid metal continuum.

At present, there is no specific use of a liquid metal as a fluid phase in a gel material. In addition, in order to solve the problems of incompatibility between the polymer network and metal in the gel, structural phase separation and degraded mechanical properties potentially caused when a large amount of liquid metal is introduced into the gel, a novel gel material is developed on the basis of the gel system in this solution. The liquid metal is used as a fluid phase in the gel, and the nano-dispersed three-dimensional porous polymer network is uniformly and stably dispersed in the liquid metal fluid by an interactive force, thus achieving high electronic conductivity and softness. The material can maintain stable performances even when the material undergoes physical deformation or is in different environments, thus solving the problems that no liquid metal is used as a fluid phase at present, the compatibility between the liquid metal and the polymer network is poor, and the electronic conductivity of the gel material is low.

The present invention and implementations thereof have been described illustratively above; however, the description is non-limiting. The present invention can be implemented in other specific forms without departing from the spirit or basic characteristics of the present invention. The drawings show only one of the implementations of the present invention, and the actual structure is not limited thereto, and any reference numberals in the claims should not limit the claims involved. Therefore, similar structures and embodiments designed by a person of ordinary skill in the art as inspired by the disclosure herein without departing from the spirit of the present invention and without creative efforts shall fall within the protection scope of the present invention. In addition, the word “comprising” or “including” does not exclude other elements or steps, and the word “a” or “an” before an element does not exclude “a plurality” of the element. A plurality of elements stated in the product claims can also be implemented by one element through software or hardware. The words first and second are used to indicate names, but not any particular order.

What is claimed is:

1. A method for preparing a metalgel, comprising the following steps:
preparing a polymer solution by adding a polymer powder to a good solvent, dissolving, and stirring until uniform, to a polymer solution;
preparing a liquid metal-polymer mixed solution by adding a liquid metal to the polymer solution, uniformly dispersing the mixed solution by a homogenizer, to obtain the liquid metal-polymer mixed solution; and
treating the liquid metal-polymer mixed solution by removing the good solvent from the uniformly dispersed mixed solution by heating, freeze drying, or other methods, to obtain the metalgel.

2. The method for preparing a metalgel according to claim 1, wherein
the polymer solution is prepared by preparing a t-type carrageenan solution; preparing a sodium alginate solution; preparing a gellan gum solution; preparing a hyaluromic acid solution;
and preparing a poly(vinylidene fluoride-hexafluoropropylene) solution.

3. The method for preparing a metalgel according to claim 2, wherein
the ι-type carrageenan solution is prepared specifically by dissolving 0.80 wt %-4.80 wt % of a t-type carrageenan power in deionized water, and continuously magnetically stirring for 2 hrs at a temperature of 80° C. until the power is dissolved, to obtain the t-type carrageenan solution; and
the sodium alginate solution is prepared specifically by dissolving 0.80 wt %-4.80 wt % of a sodium alginate powder in deionized water, and continuously magnetically stirring for 2 hrs at a temperature of 25° C. until the power is dissolved, to obtain the sodium alginate solution.

4. The method for preparing a metalgel according to claim 2, wherein
the gellan gum solution is prepared specifically by dissolving 0.80 wt %-4.80 wt % of a gellan gum powder in deionized water, and continuously magnetically stirring for 2 hrs at a temperature of 25° C. until the power is dissolved, to obtain the gellan gum solution;
the hyaluromic acid solution is prepared specifically by dissolving 0.80 wt %-4.80 wt % of a hyaluromic acid powder in deionized water, and continuously magnetically stirring for 2 hrs at a temperature of 25° C. until the powder is dissolved, to obtain the hyaluromic acid solution; and
the poly(vinylidene fluoride-hexafluoropropylene) solution is prepared specifically by dissolving 0.80 wt %-4.80 wt % of poly(vinylidene fluoride-hexafluoropropylene) particles in N-methylpyrrolidone, and continuously magnetically stirring for 2 hrs at a temperature of 25° C. until the particles are dissolved, to obtain the poly(vinylidene fluoride-hexafluoropropylene) solution.

5. The method for preparing a metalgel according to claim 1, wherein
the liquid metal-polymer mixed solution is prepared by preparing a gallium-indium alloy-t-type carrageenan mixed solution; preparing a gallium-ι-type carrageenan mixed solution; preparing a gallium-indium-tin alloy-ι-type carrageenan mixed solution; preparing a gallium-indium alloy-sodium alginate mixed solution; preparing gallium-indium alloy-gellan gum mixed solution; preparing a gallium-indium alloy-hyaluromic acidmixed solution; and preparing a gallium-indium alloy-poly(vinylidene fluoride-hexafluoropropylene) mixed solution.

6. The method for preparing a metalgel according to claim 5, wherein
the liquid metal-polymer mixed solution is prepared specifically by
mixing liquid metal gallium-indium alloy with the t-type carrageenan solution at a weight ratio of 1:1-7:3, and stirring and shearing for 5 min-15 min by a hand-held homogenizer at a speed of 8000 rpm-15000 rpm at a temperature of 80° C., to obtain the gallium-indium alloy-ι-type carrageenan mixed solution;
mixing liquid metal gallium with the t-type carrageenan solution at a weight ratio of 1:1-7:3, and stirring and shearing for 5 min-15 min by a hand-held homogenizer at a speed of 8000 rpm-15000 rpm at a temperature of 80° C., to obtain the gallium-ι-type carrageenan mixed solution; and
mixing liquid metal gallium-indium-tin alloy with the t-type carrageenan solution at a weight ratio of 1:1-7:3, and stirring and shearing for 5 min-15 min by a hand-held homogenizer at a speed of 8000 rpm-15000 rpm at a temperature of 80° C., to obtain the gallium-indium-tin alloy-ι-type carrageenan mixed solution.

7. The method for preparing a metalgel according to claim 6, wherein
the liquid metal-polymer mixed solution is further prepared by
mixing liquid metal gallium-indium alloy with the sodium alginate solution at a weight ratio of 1:1-7:3, and stirring and shearing for 5 min-15 min by a hand-held homogenizer at a speed of 8000 rpm-15000 rpm at a temperature of 25° C., to obtain the gallium-indium alloy-sodium alginate mixed solution;
mixing liquid metal gallium-indium alloy with the gellan gum solution at a weight ratio of 1:1-7:3, and stirring and shearing for 5 min-15 min by a hand-held homogenizer at a speed of 8000 rpm-15000 rpm at a temperature of 25° C., to obtain the gallium-indium alloy-gellan gum mixed solution;
mixing liquid metal gallium-indium alloy with the hyaluromic acid solution at a weight ratio of 1:1-7:3, and stirring and shearing for 5 min-15 min by a hand-held homogenizer at a speed of 8000 rpm-15000 rpm at a temperature of 25° C., to obtain the gallium-indium alloy-hyaluromic acid mixed solution; and
mixing liquid metal gallium-indium alloy with the poly(vinylidene fluoride-hexafluoropropylene) solution at a weight ratio of 1:1-7:3, and stirring and shearing for 5 min-15 min by a hand-held homogenizer at a speed of 8000 rpm-15000 rpm at a temperature of 25° C., to obtain the gallium-indium alloy-poly(vinylidene fluoride-hexafluoropropylene) mixed solution.

8. The method for preparing a metalgel according to claim 7, wherein
the liquid metal-polymer mixed solution is treated specifically by
adding the liquid metal-polymer mixed solution to a polytetrafluoroethylene dish, and removing the good solvent by allowing the dish to stand in an environment of 25° C.-80° C., to obtain the metalgel.

9. A novel metalgel prepared by the method for preparing a metalgel according to claim 1, comprising a liquid metal and a polymer network,
wherein the liquid metal forms a continuum to serve as a fluid phase in the gel; and
the nano-scale polymer network immobilizes the liquid metal fluid through interaction.
